(19) United States
(12) Patent Application Publication
(10) Pub. No.: US 2007/0150950 A1
(43) Pub. Date: Jun. 28, 2007

(54) Methods, communication networks, and computer program products for mirroring traffic associated with a network element based on whether the network element can be trusted

(76) Inventors: Jeffrey Aaron, Atlanta, GA (US); Edgar Shrum JR., Smyrna, GA (US)

Correspondence Address: MYERS BIGEL SIBLEY & SAJOVEC, P.A., P.O. BOX 37428, RALEIGH, NC, 27627, US

(21) Appl. No.: 11/315,674

(22) Filed: Dec. 22, 2005

(51) Int. Cl. G06F 12/14

(52) U.S. Cl. 726/22

(57) ABSTRACT

A communication network is operated by determining whether a network element can be trusted and mirroring traffic associated with the network element based on whether the network element can be trusted.

### FIELD OF THE INVENTION

The present invention relates to communication networks and methods of operating the same, and, more particularly, to methods, systems, and computer program products for mirroring of traffic on communication networks.

### BACKGROUND OF THE INVENTION

Automatic network-based mirroring of traffic may be desired in certain scenarios, in particular if a network element has been modified in an undesirable fashion. For example, law enforcement and/or homeland security authorities may desire to monitor traffic in certain circumstances. Network security personnel may wish to monitor traffic when equipment or software is compromised in some way. Where loss of trust in a network element is associated with malfunctions of some kind, network operations personnel may wish to monitor the associated traffic. Monitoring in these or other situations may be accomplished by mirroring the traffic, or some portion of the traffic, to a point in the network where monitoring is performed. Additionally, mirroring may be desired for purposes other than monitoring, for example, to store a copy of some portion of the traffic. Traditionally, mirroring of traffic has been done using static/manual techniques. These techniques, however, may be costly, inflexible, and may take a considerable amount of time to set up in that they are typically manually provisioned.

### SUMMARY OF THE INVENTION

According to some embodiments of the present invention, a communication network is operated by determining whether a network element can be trusted and mirroring traffic associated with the network element based on whether the network element can be trusted.

In other embodiments, determining whether a network element can be trusted, comprises generating a first hash value based on data associated with the network element, generating a second hash value based on the data associated with the network element, and comparing the first hash value with the second hash value to determine whether the network element can be trusted.

In still other embodiments, comparing the first hash value with the second hash value to determine whether the network element can be trusted comprises comparing the first hash value with the second hash value to determine a degree of trust for the network element.

In still other embodiments, mirroring traffic comprises selecting traffic for mirroring using rules that are based on the degree of trust for the network element.

In still other embodiments, selecting traffic comprises selecting traffic for mirroring based on packet header, class/Quality of Service, associated communication streams, and/or payload contents.

In still other embodiments, selecting traffic comprises selecting traffic headers and/or traffic headers and payload contents.

In still other embodiments, mirroring traffic comprises directing the mirrored traffic to a destination based on the degree of trust for the network element.

In still other embodiments, directing the mirrored traffic to the destination comprises directing the mirrored traffic to a plurality of destinations such that different portions and/or classifications of the traffic are directed to different ones of the plurality of destinations.

In still other embodiments, generating the first hash value and generating the second hash value comprise generating the first hash value and the second hash value responsive to at least one of an expiration of a timer, a packet count associated with the network element, an event associated with then network element, and a hash generation command.

In still other embodiments, mirroring traffic associated with the network element comprises mirroring traffic associated with at least one of a location, a connection/session, and/or an application.

In still other embodiments, mirroring of the traffic associated with the network element is stopped if it is determined that the network element can be trusted and/or upon elapse of a defined mirroring time.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of exemplary embodiments thereof when read in conjunction with the accompanying drawings, in which:

FIG. 1 is a block diagram that illustrates a communication network in accordance with some embodiments of the present invention; and

FIG. 2 is a flowchart that illustrates operations of mirroring traffic associated with a network element based on whether the network element can be trusted in accordance with some embodiments of the present invention.

### DETAILED DESCRIPTION OF EXEMPLARY EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

Embodiments of the present invention are described hereafter in the context of processing a packet. It will be understood that the term “packet” means a unit of information and/or a block of data that may be transmitted electronically as a whole or via segments from one device to another. Accordingly, as used herein, the term “packet” may encompass such terms of art as “frame” and/or “message,” which may also be used to refer to a unit of transmission.

In some embodiments of the present invention, a determination can be made whether a network element is configured in an authorized manner, e.g., whether the network element is configured with authorized firmware, software, and/or data. In this regard, a determination is made whether the network element can be trusted and to what degree the network element can be trusted. Based on this determination of whether the network element can be trusted, the traffic associated with the network element can be mirrored in a desired manner. For example, what aspects of the traffic associated with the network element (e.g., headers, particular sessions, payloads, etc.) should be mirrored and to which entities the mirrored traffic should be directed (e.g., local authorities, FBI, Homeland Security, etc.) may be based on the level of trust for the network element.

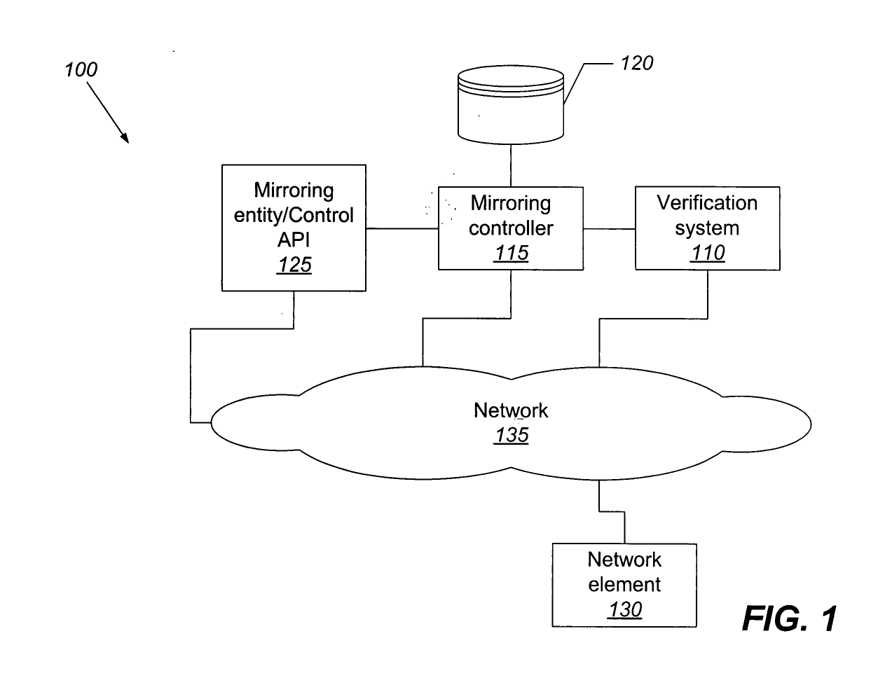

Referring now to FIG. 1, an exemplary network architecture 100 for mirroring traffic associated with a network element based on whether the network element can be trusted, in accordance with some embodiments of the present invention, comprises a verification system 110, a mirroring controller 115, a mirroring database 120, a mirroring entity/control application programming interface (API) 125, a network element 130, and a communication network 135 that are connected as shown. The network 135 may represent a global network, such as the Internet, or other publicly accessible network. The network 135 may also, however, represent a wide area network, a local area network, an Intranet, or other private network, which may not accessible by the general public. Furthermore, the network 135 may represent a combination of public and private networks or a virtual private network (VPN).

The verification system 110 may be configured to determine whether the network element 130 is trustable or not, by, for example, determining a degree of trust for the network element 130. This trust information may then be provided to the mirroring controller 115. The verification system 110 may be embodied as described in, for example, U.S. patent application Ser. No. 10/880,249 entitled “Verification of Consumer Equipment Connected to Packet Networks Based on Hashing Values” (hereinafter '249 application), and U.S. patent application Ser. No. 10/886,169 entitled “Controlling Quality of Service and Access in a Packet Network Based on Levels of Trust for Consumer Equipment” (hereinafter '169 application), the disclosures of which are hereby incorporated herein by reference in their entireties.

As described in the '249 application and '169 application, the verification system 110 can determine a level of trust for the network element 130 by generating first and second hash values based on data that is associated with the network element 130. This data may represent any type of software and/or firmware, for example, associated with the network element 130. If the hash values are not identical, then an evaluation may be made whether the network element 130 can be trusted and/or what degree of trust may be assigned to the network element 130.

As used herein, the term “network element” includes any device that is configured to communicate traffic, such as packet traffic, using the communication network 135. Accordingly, the network element 130 may be, but is not limited to, a router, a gateway, a switching device, a cable modem, a digital subscriber line modem, a public switched telephone network modem, a wireless local area network modem, a wireless wide area network modem, a computer with a modem, a mobile terminal such as personal data assistant and/or cellular telephone with a modem. For network elements that communicate via the communication network 135 through a wireless interface, wireless protocols, such as, but not limited to, the following may be used: a cellular protocol (e.g., General Packet Radio System (GPRS), Enhanced Data Rates for Global Evolution (EDGE), Global System for Mobile Communications (GSM), code division multiple access (CDMA), wideband-CDMA, CDMA2000, and/or Universal Mobile Telecommunications System (UMTS)), a wireless local area network protocol (e.g., IEEE 802.11), a Bluetooth protocol, another RF communication protocol, and/or an optical communication protocol.

The mirroring controller 115 may be configured to obtain trust and/or degree of trust information for network element(s) 130 from the verification system 110. In some embodiments, trust-relevant information from additional sources could alternately or additionally be considered. Such additional trust-relevant sources may include, but are not limited to, various network management systems, policy-based control systems, monitoring systems, including intrusion detection/protection systems, security scanning systems, third party security notification systems, outsourced security consulting/management services/systems, and/or security relevant information aggregation systems. Based on this trust information, the mirroring controller may determine what traffic or portions of traffic associated with the network element 130 should be mirrored and where the traffic should be mirrored. The mirroring controller 115 may access the mirroring database 120 to access rules, patterns, and/or decision data that may be used in determining what traffic to mirror and where the mirrored traffic should be directed. The mirroring database 120 may further store addresses for various network element(s) 130 in the communication network 135 and/or addresses for entities to which mirrored traffic may be directed.

The mirroring entity/control API 125 may be configured to communicate with the mirroring controller 115 to configured the appropriate devices/elements in the communication network 135 to carry out mirroring of traffic associated with one or more network elements 130. In accordance with various embodiments of the present invention, the mirroring entity/control API may be implemented as a singular entity that carries out commands received from the mirroring controller 115 or may be an API that allows for control of traffic mirroring at a subscriber, premises, and/or application level.

The mirroring entity/control API 125 may also be configured to monitor the status of a traffic mirroring operation and provide such status information to the mirroring controller 115 where it may be stored in the mirroring database 120. The mirroring controller 115 may generate alarms and/or indicators based on the status of the mirroring operation.

Although FIG. 1 illustrates an exemplary communication network, it will be understood that the present invention is not limited to such configurations, but is intended to encompass any configuration capable of carrying out the operations described herein.

The verification system 110, mirroring controller 115, and/or mirroring entity/control API 125 may be embodied as one or more data processing systems that comprise, for example, input device(s), such as a keyboard or keypad, a display, and a memory that communicate with a processor. Such data processing system(s) may further include a storage system, a speaker, and an input/output (I/O) data port(s) that also communicate with the processor. The storage system may include removable and/or fixed media, such as floppy disks, ZIP drives, hard disks, or the like, as well as virtual storage, such as a RAMDISK. The I/O data port(s) may be used to transfer information between the data processing system(s) and another computer system or a network (e.g., the Internet). These components may be conventional components such as those used in many conventional computing devices, which may be configured to operate as described herein. Moreover, the functionality of the verification system 110, mirroring controller 115, and/or mirroring entity/control API 125 may be implemented as a single processor system, a multi-processor system, or even a network of stand-alone computer systems, in accordance with various embodiments of the present invention.

Computer program code for carrying out operations of the verification system 110, mirroring controller 115, and/or mirroring entity/control API 125 may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

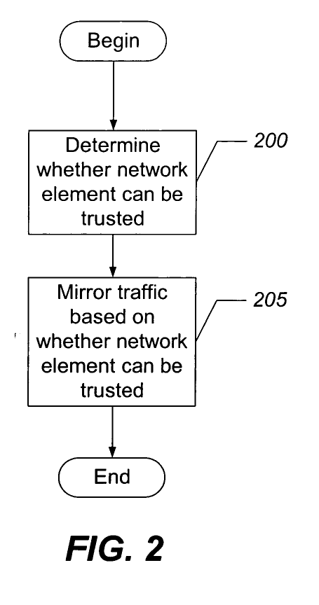

Exemplary operations for mirroring traffic associated with a network element based on whether the network element can be trusted, in accordance with some embodiments of the present invention, will now be described with reference to FIGS. 2 and 1. Operations begin at block 200 where the verification system 110 determines whether a network element 130 can be trusted and/or to what degree that network element can be trusted. As discussed above and in detail in the '249 application and the '169 application, the verification system 110 may determine a degree of trust for a network element 130 by comparing hash values generated for data associated with the network element 130. Advantageously, the verification system 110 may be configured to automatically evaluate the network element 130 to determine a degree of trust for the network element 130. For example, the verification system 110 may generate a hash value for data associated with the network element 130 every time a timer expires, a packet-count is reached, a particular event occurs at the network element 130, such as, for example the start of a session initiation protocol (SIP) or Voice over Internet Protocol (VoIP) session, and/or a direct command to perform a hash operation on the data associated with the network element 130 is issued.

At block 205, the traffic associated with the network element 130 is mirrored based on whether the network element 130 can be trusted. As discussed above, the mirroring controller 115 may select traffic associated with the network element 130 to be mirrored based on rules stored in the mirroring database 120. These rules may be based on the degree of trust determined for the network element 130. For example, the mirroring controller 115 may use the rules stored in the mirroring database 120 to filter the traffic to be mirrored based on packet header (e.g., source/destination address, ports, protocol), class/Quality of Service, associated communication streams or conversations, and/or the contents of the traffic payloads.

The mirroring controller 115 may also select what portions of the traffic associated with the network element 130 are to be mirrored based on rules stored in the mirroring database. For example, the traffic headers may be mirrored, the traffic headers and payloads may be mirrored, a subset of the traffic headers may be mirrored, a subset of the traffic headers and payloads may be mirrored, and/or a periodic or random sampling of any of the foregoing may be mirrored. Moreover, in accordance with various embodiments of the present invention, the scope of the traffic associated with the network element 130 may comprise traffic associated with a location, a connection/session, and/or an application.

The mirroring controller 115 may direct the mirrored traffic to a destination based, for example, on the degree of trust associated with the network element 130. In some embodiments, the mirrored traffic may be directed to a plurality of destinations such that different portions and/or classifications of traffic are directed to different ones of the plurality of destinations.

Mirroring of the traffic associated with a network element 130 may be stopped, for example, when it is determined that the network element 130 can be trusted and/or upon a lapse of a defined mirroring time. The mirroring entity/control API 125 may also monitor the status of the mirroring operation to determine if any errors have occurred that may justify another attempt at mirroring the traffic associated with the network element 130 and/or provide the mirroring controller 115 with information used to evaluate the success and/or progress of the mirroring operation.

The flowchart of FIG. 2 illustrates the architecture, functionality, and operations of some embodiments of methods, systems, and computer program products for mirroring traffic associated with a network element based on whether the network element can be trusted. In this regard, each block represents a module, segment, or portion of code, which comprises one or more executable instructions for implementing the specified logical function(s). It should also be noted that in other implementations, the function(s) noted in the blocks may occur out of the order noted in FIG. 2. For example, two blocks shown in succession may, in fact, be executed substantially concurrently or the blocks may sometimes be executed in the reverse order, depending on the functionality involved.

Some embodiments of the present invention may be illustrated by way of example. Some time in the past, the verification system 110 checks the configuration of Merlin's modem such that an initial acceptable hash result is recorded. After expiration of a timer, the verification system 110 re-checks Merlin's modem to record recent hash results. Merlin then initiates a high-quality SIP videoconference. The verification system 110 either re-checks Merlin's modem to generate a new hash result or accesses the most recent hash result and performs a compare with the initial acceptable hash result. The verification system 110 determines that a change has occurred such that the level of trust for Merlin's modem has been compromised. As a result, mirroring of communication-based services (voice and video) is required. The verification system 110 reports a degree of trust for Merlin's modem as 3 out of 10 to the mirroring controller 115. The mirroring controller 115 consults the mirroring database 120 to determine that for a trust value of 3 headers plus payloads are to be mirrored for traffic associated with all communication streams/sessions. The mirroring controller 115 further consults the mirroring database to determine that the appropriate mirroring destination is a local law enforcement agency. The mirroring entity/control API 125 configures a router close to Merlin's modem to perform the mirroring of traffic associated with Merlin's modem. Merlin's videoconference is mirrored for analysis and the mirroring session is monitored with no errors incurred. The problem in Merlin's modem is eventually corrected, which is noted in the mirroring database 120. The mirroring session is then canceled.

Many variations and modifications can be made to the embodiments described herein without substantially departing from the principles of the present invention. All such variations and modifications are intended to be included herein within the scope of the present invention, as set forth in the following claims.

That which is claimed:

1. A method of operating a communication network, comprising:
determining whether a network element can be trusted; and
mirroring traffic associated with the network element based on whether the network element can be trusted.

2. The method of claim 1, wherein determining whether a network element can be trusted, comprises:
generating a first hash value based on data associated with the network element;
generating a second hash value based on the data associated with the network element; and
comparing the first hash value with the second hash value to determine whether the network element can be trusted.

3. The method of claim 2, wherein comparing the first hash value with the second hash value to determine whether the network element can be trusted comprises comparing the first hash value with the second hash value to determine a degree of trust for the network element.

4. The method of claim 1, wherein mirroring traffic comprises:
selecting traffic for mirroring using rules that are based on network element trust information.

5. The method of claim 4, wherein selecting traffic comprises:
selecting traffic for mirroring based on packet header, class/Quality of Service, associated communication streams, and/or payload contents.

6. The method of claim 4, wherein selecting traffic comprises:
selecting traffic headers and/or traffic headers and payload contents.

7. The method of claim 1, wherein mirroring traffic comprises:
directing the mirrored traffic to a destination based on whether the network element can be trusted.

8. The method of claim 7, wherein directing the mirrored traffic to the destination comprises:
directing the mirrored traffic to a plurality of destinations such that different portions and/or classifications of the traffic are directed to different ones of the plurality of destinations.

9. The method of claim 2, wherein generating the first hash value and generating the second hash value comprise:
generating the first hash value and the second hash value responsive to at least one of an expiration of a timer, a packet count associated with the network element, an event associated with then network element, and a hash generation command.

10. The method of claim 1, wherein mirroring traffic associated with the network element comprises:
mirroring traffic associated with at least one of a location, a connection/session, and/or an application.

11. The method of claim 1, further comprising:
stopping mirroring of the traffic associated with the network element if it is determined that the network element can be trusted and/or upon elapse of a defined mirroring time.

12. A computer program product for operating a communication network, comprising:
a computer readable storage medium having computer readable program code embodied therein, the computer readable program code being configured to carry out the method of claim 1.

13. A communication network, comprising:
a verification system that is configured to determine whether a network element can be trusted; and
a mirroring controller that is connected to the verification system and is configured to mirror traffic associated with the network element based on whether the network element can be trusted.

14. The communication network of claim 13, wherein the verification system is further configured to generate a first hash value based on data associated with the network element, generate a second hash value based on the data associated with the network element, and compare the first hash value with the second hash value to determine whether the network element can be trusted.

15. The communication network of claim 14, wherein the verification system is further configured to compare the first hash value with the second hash value to determine a degree of trust for the network element.

16. The communication network of claim 15, further comprising:
a mirroring database connected to the mirroring controller that comprises rules for selecting traffic that are based on the degree of trust for the network element;
wherein the mirroring controller is further configured to select traffic for mirroring using the rules for selecting traffic.

17. The communication network of claim 16, wherein the mirroring controller is further configured to select traffic headers and/or traffic headers and payload contents.

18. The communication network of claim 15, wherein the mirroring controller is further configured to direct the mirrored traffic to a destination based on the degree of trust for the network element.

19. The communication network of claim 13, wherein the mirroring controller is further configured to mirror traffic associated with at least one of a location, a connection/session, and/or an application.

20. The communication network of claim 13, wherein the mirroring controller is further configured to stop mirroring of the traffic associated with the network element if it is determined that the network element can be trusted and/or upon elapse of a defined mirroring time.
